(19) United States
(12) Patent Application Publication
(10) Pub. No.: US 2012/0090705 A1
(43) Pub. Date: Apr. 19, 2012

(54) GAS PRESSURE REGULATOR SYSTEM

(75) Inventors: Shmuel Dovid Newman, Redondo Beach, CA (US); Jeffrey Brown, North Logan, UT (US)

(73) Assignee: YSN Imports, Inc., Gardena, CA (US)

(21) Appl. No.: 13/221,846

(22) Filed: Aug. 30, 2011

Related U.S. Application Data
(60) Provisional application No. 61/379,202, filed on Sep. 1, 2010.

(51) Int. Cl. F16K 15/00

(52) U.S. Cl. 137/535

(57) ABSTRACT

A gas pressure regulator system comprises a regulator body and a separate port collar. The regulator body has a high pressure chamber and a low pressure chamber, and generally houses a regulator valve system to control the pressure of the fluid moving from the high pressure chamber to the low pressure chamber. The port collar has at least one high pressure port and one low pressure port, and is adapted to be mounted on the regulator body. When the port collar is in its mounted position, the high pressure ports are in fluid communication with the high pressure chamber, and the low pressure port is in fluid communication with the low pressure chamber. The port collar may be rotatable with respect to the regular body without disrupting the fluid communication between respective chambers and pressure ports. The high pressure ports may accommodate such fixtures as a high pressure burst disk assembly, a fill nipple or a pressure gauge. The low pressure port may accommodate a low pressure burst disk.

### RELATED APPLICATIONS

This application claims the benefit of U.S. Provisional Application No. 61/379,202, filed on Sep. 1, 2010, the content of which is incorporated by this reference in its entirety for all purposes as if fully set forth herein.

### TECHNICAL FIELD

The present invention relates generally to regulators for regulating gas from a tank that contains compressed gas to a paintball gun, marker, or other application designed to utilize or be activated by gas at a controlled pressure.

### BACKGROUND

Pressure regulators are commonly relied on to reduce the pressure of a gas as it is delivered from a pressurized gas reservoir, such as a portable compressed air tank, to an application device, such as a paintball marker. Paintball markers may feature a gas pressure regulator directly connected to the mouth of a tank designed to store gasses at very high pressures, typically between 3000-4500 psi. Commonly referred to as “tank regulators,” these gas pressure regulators may reduce the pressure of the gas delivered from the tank down to, for example, 600-800 psi before the gas enters the paintball marker for use in firing a projectile.

Given the high pressures involved and the proximity of the pressurized tanks to the players, it is desirable for tank regulators to feature one or more pressure relief mechanisms, such as a burst disk, and in some cases a pressure gauge. However, these safety and monitoring mechanisms can protrude radially outward from the regulator in ways which may cause injury to the player or the regulator components. Moreover, there is significant cost and complexity involved in machining a durable regulator body which simultaneously provides a housing for the regulator valve components and multiple external ports to accommodate fixtures such as burst disks, pressure gauges and fill nipples.

### SUMMARY

The shortcomings of the prior art are overcome and additional advantages are provided by a gas pressure regulator system comprising a regulator body and a separate port collar. The regulator body has a high pressure chamber and a low pressure chamber. The low pressure chamber receives pressurized fluid from the high pressure chamber in a manner controlled by a regulator valve subsystem. The port collar has at least one high pressure port and one low pressure port, and is adapted to be mounted on the regulator body. When the port collar is in its mounted position, the high pressure ports are in fluid communication with the high pressure chamber, and the low pressure port is in fluid communication with the low pressure chamber.

The high pressure ports may accommodate such fixtures as a high pressure burst disk assembly, a fill nipple or a pressure gauge. The low pressure port may accommodate, for example, a low pressure burst disk. To reduce manufacturing costs, the port collar and regulator body may be made of different materials, such as aluminum and brass, respectively. They may also be machined or otherwise formed independently of each other. The source end of the regulator body can be threaded into a source fitting which is in fluid communication with a reservoir for storing pressurized fluid.

The gas pressure regulator system also includes a poppet member and an application interface member toward the application end of the regulator system. A gas receipt fitting of an application device, such as a paintball marker, can be threaded onto the application interface member. Once the poppet member is pressed toward its open position, gas under regulated pressure can flow from the low pressure chamber to the application device. The application interface member of some embodiments can be placed in various rotational positions prior to being affixed non-rotatably to the regulator body.

The regulator body may also feature a torque engagement portion. The torque engagement portion can serve to interact with the application interface member to prevent its rotation with respect to the regulator body, and also to engage a torque tool, such as an adjustable or socket wrench, to assist in securing the threaded engagement of the regulator body to a fluid reservoir housing as well as the threaded removal therefrom.

### BRIEF DESCRIPTION OF THE DRAWINGS

Further advantages of the present invention may become apparent to those skilled in the art with the benefit of the following detailed description of the preferred embodiments and upon reference to the accompanying drawings in which:

FIG. 1 is a diagrammatic cross-sectional view of an embodiment of a gas pressure regulator system, shown with the regulator body threadedly engaged with a fluid reservoir;

FIG. 2 is a diagrammatic exploded view of the embodiment depicted in FIG. 1;

FIG. 3 is a diagrammatic perspective view of the embodiment depicted in FIG. 1;

FIG. 4 is a further diagrammatic perspective view of the embodiment of

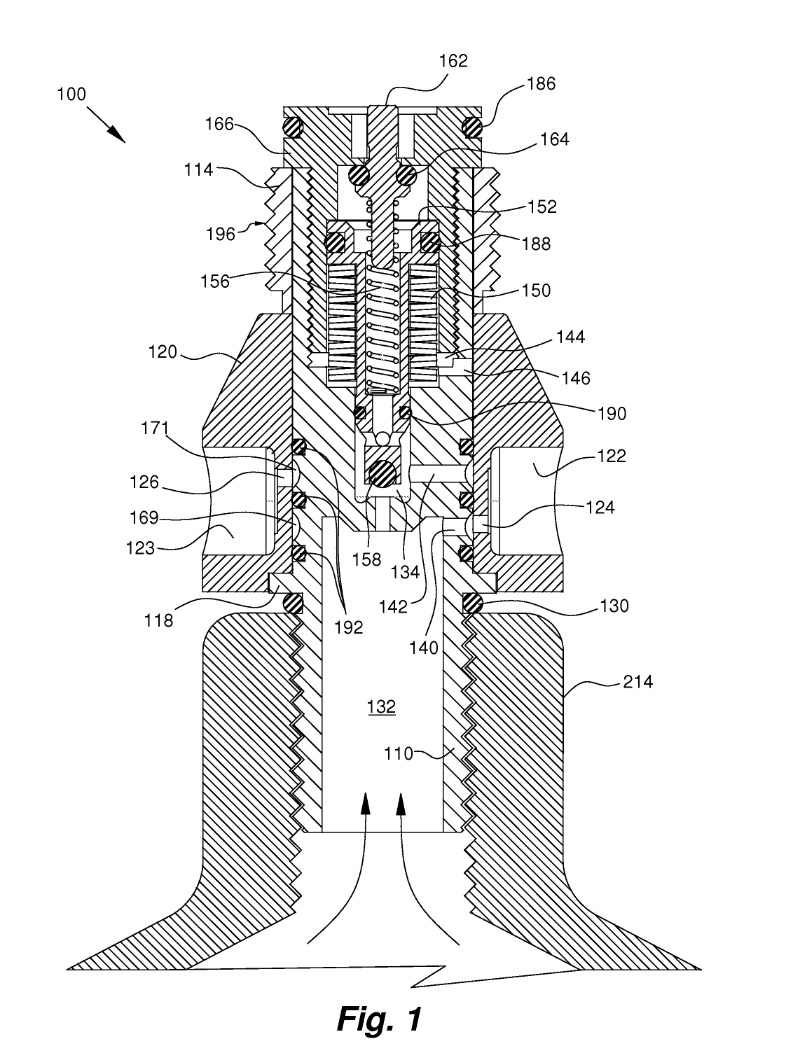

FIG. 1;

FIG. 5 is a diagrammatic perspective view of a regulator body of the embodiment depicted in FIG. 1;

FIG. 6 is a diagrammatic side view of the regulator body depicted in FIG. 5;

FIG. 7 is a diagrammatic cross-sectional view taken along line 7-7 in FIG. 6;

FIG. 8 is a diagrammatic perspective view of a port collar of the embodiment depicted in FIG. 1;

FIG. 9 is a further diagrammatic perspective view of a port collar of the embodiment depicted in FIG. 1;

FIG. 10 is a diagrammatic side view of the port collar depicted in FIG. 9;

FIG. 11 is a diagrammatic cross-sectional view taken along line 11-11 in FIG. 10;

FIG. 12 is a diagrammatic cross-sectional view taken along line 12-12 in FIG. 10;

FIG. 13 is a diagrammatic cross-sectional view taken along line 13-13 in FIG. 10;

FIG. 14 is a diagrammatic perspective view of a retainer member of the embodiment depicted in FIG. 1;

FIG. 15 is a diagrammatic cross-sectional of the retainer member depicted in FIG. 14;

FIG. 16 is a diagrammatic perspective view of an application interface member of the embodiment depicted in FIG. 1;

FIG. 17 is a diagrammatic top end view of the application interface member depicted in FIG. 16;

FIG. 18 is a diagrammatic side view of a piston of the embodiment of a gas pressure regulator system depicted in FIG. 1;

FIG. 19 is a diagrammatic cross-sectional view taken along line 19-19 in FIG. 18;

FIG. 20 is a diagrammatic perspective view of the piston depicted in FIG. 18;

FIG. 21 is a further diagrammatic perspective view of the piston depicted in FIG. 18;

FIG. 22 is a diagrammatic perspective view of another embodiment of a gas pressure regulator system;

FIG. 23 is a further diagrammatic perspective view of the embodiment depicted in FIG. 22;

FIG. 24 is a diagrammatic side view of the embodiment depicted in FIG. 22;

FIG. 25 is a diagrammatic cross-sectional view taken along line 25-25 in FIG. 24;

FIG. 26 is a diagrammatic perspective view of a regulator body of the embodiment depicted in FIG. 22;

FIG. 27 is a diagrammatic side view of the regulator body depicted in FIG. 26;

FIG. 28 is a diagrammatic cross-sectional view taken along line 28-28 in FIG. 27;

FIG. 29 is a diagrammatic perspective view of a port collar of the embodiment depicted in FIG. 22;

FIG. 30 is a diagrammatic side view of the port collar depicted in FIG. 29;

FIG. 31 is a diagrammatic cross-sectional view taken along line 31-31 in FIG. 30;

FIG. 32 is a diagrammatic perspective view of a retainer member of the embodiment depicted in FIG. 22;

FIG. 33 is a diagrammatic cross-sectional view of the retainer member depicted in FIG. 32;

FIG. 34 is a diagrammatic side view of another embodiment of a gas pressure regulator system; and

FIG. 35 is a diagrammatic cross-sectional view taken along line 35-35 in FIG. 34;

### DETAILED DESCRIPTION OF THE PREFERRED EMBODIMENTS

Referring now to the drawings, like reference numerals designate identical or corresponding features throughout the several views.

Referring to FIG. 1, an embodiment of a gas pressure regulator system is shown generally at 100, and comprises a regulator body 110 and a port collar 120. In certain embodiments, regulator body 110 has threading (the location of which is shown generally at 194 in FIGS. 5-7) proximate the source end 112. The threading 194 may be adapted to threadedly engage a source fitting 214 in fluid communication with a reservoir for pressurized fluid. Embodiments may include a source seal 130 to help establish a gas-tight seal between, for example, the source fitting and the regulator system 100. As depicted in FIG. 1, the source fitting 214 can be, for example, the neck portion of a high pressure tank used in association with paintball guns. Regulator body 110 may also include one or more bleed channels 116 to facilitate its safe removal from the source fitting while residual pressurized gas remains within the reservoir.

Referring to FIGS. 5-7, the regulator body 110 has a source end 112, an application end 113, a body axis 117 extending generally therebetween, a high pressure chamber 132, a low pressure chamber 134 and a valve chamber 148. The low pressure chamber 134 is adapted to receive pressurized gas from the high pressure chamber 132 in a manner controlled by a regulator valve subsystem. The regulator valve subsystem may comprise a piston 152, a first piston seal member 188, a second piston seal member 190, a seal member 158 positioned within second hollow piston interior 184 and piston spring 150. The seal member 158 is typically elastomeric, and cooperates with the valve seat 176 of the regulator body 110. The piston spring 150 may be of the Belleville type. Referring to FIGS. 18-21, the piston 152 may include piston bores 160, a fillet or chamfer 182 and a first hollow piston interior 154.

Referring to FIGS. 8-13, the port collar 120 has at least one high pressure port 122 and one low pressure port 123. The port collar 120 is adapted to receivingly engage the regulator body 110 for placement of the port collar 120 in a mounted position on the regulator body 110. Such receiving engagement and placement is depicted, for example, in FIG. 1. In continued reference to FIG. 1, when the port collar 120 is in its mounted position, the high pressure ports 122 are in fluid communication with the high pressure chamber 132 (typically by way of high pressure port bores 124), and the low pressure port 123 is in fluid communication with the low pressure chamber 134 (typically by way of low pressure port bore 126). The port collar 120 may also feature a chamfer or other taper toward its outward leading edge, saving on material costs while reducing the weight and the physical profile of the gas pressure regulator system 100.

The high pressure ports 122 may threadedly accommodate such fixtures as a high pressure burst disk assembly, a fill nipple or a pressure gauge (not shown). The low pressure port 123 may threadedly accommodate, for example, a low pressure burst disk (not shown). To help reduce manufacturing costs, the port collar 120 and regulator body 110 may be made of different materials. For example, the port collar can be made substantially of aluminum while the regulator body can be made substantially of brass. The may also be machined or otherwise formed independently of one another.

Referring to FIG. 1, in typical embodiments, the regulator body 110 has a high side bore 140, a low side bore 142 and an ambient bore 146. In such embodiments, the regulator body 110 is adapted such that when the port collar 120 is in its mounted position, the high side bore 140 is in fluid communication between the high pressure chamber 132 and the high pressure ports 122, the low side bore 142 is in fluid communication between the low pressure chamber 134 and the low pressure port 123, and the ambient bore 146 is in general fluid communication between the ambient pressure chamber 144 and the ambient environment, typically by way of micro fissures between the regulator body 110 and port collar 120.

Referring to FIG. 7, in particular embodiments, the regulator body 110 has a first annular groove 168 and a second annular groove 170. In such embodiments, the high side bore 140 is in fluid communication between the high pressure chamber 132 and the first annular groove 168, and the low side bore 142 is in fluid communication between the low pressure chamber 134 and the second annular groove 170. In embodiments, the regulator body 110 may also have three gasket grooves 174, in which case the first annular groove 168 and the second annular groove 170 are each axially flanked by two of the gasket grooves 174. In certain embodiments, the first annular groove 168 or second annular groove 170 may not completely circumscribe the regulator body 110.

Returning to FIG. 1, each of three port collar o-rings 192 may be positioned within a respective one of the gasket grooves 174 and generally between the regulator body 110 and the port collar 120. In combination with the first annular groove 168 and the second annular groove 170, this arrangement typically forms a first annular channel 169 in fluid communication with the high pressure chamber 132, and a second annular channel 171 in fluid communication with the low pressure chamber 134. As a result, regardless of the rotational orientation of the port collar 120 with respect to the regulator body 110, the high pressure ports 122 will remain in fluid communication with the high pressure chamber 132, and the low pressure port 123 will remain in fluid communication with the low pressure chamber 134.

Embodiments typically further comprise an application interface member 114 adapted to engage the regulator body 110 proximate the application end 113 in non-rotatable fashion, and releasably engage a gas receipt fitting of an application device, such as a paintball marker. As illustrated generally at 196 in FIG. 1, the application interface member 114 may be adapted to threadedly engage the gas receipt fitting (not shown). Embodiments may include an application seal member 186 to help establish a gas-tight seal between the gas receipt fitting and the regulator system 100.

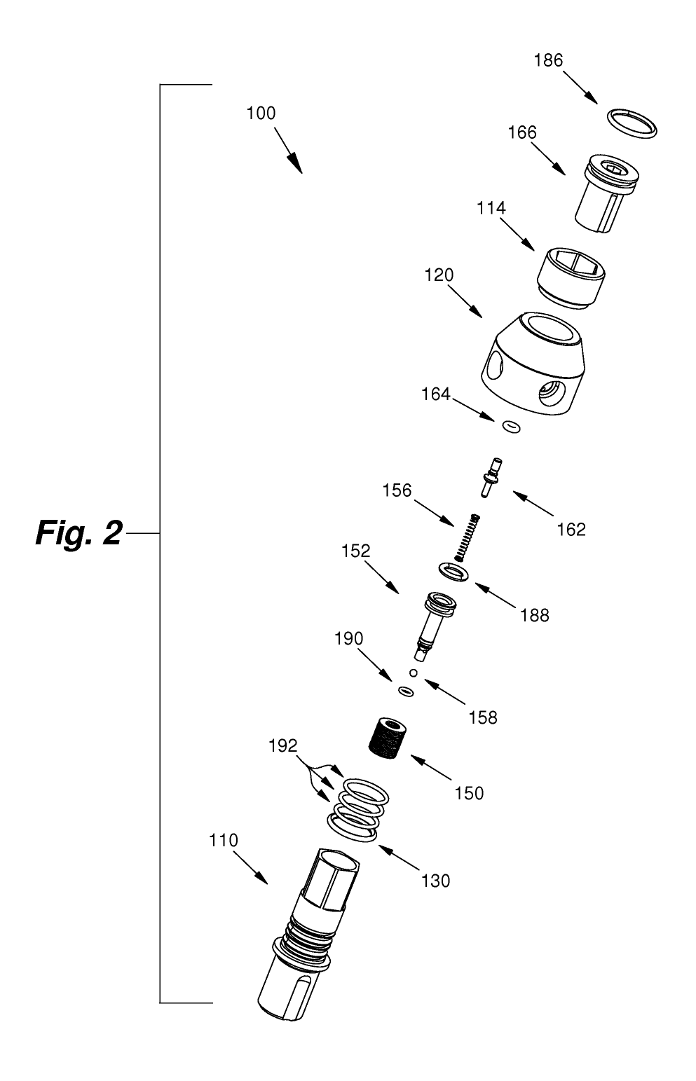

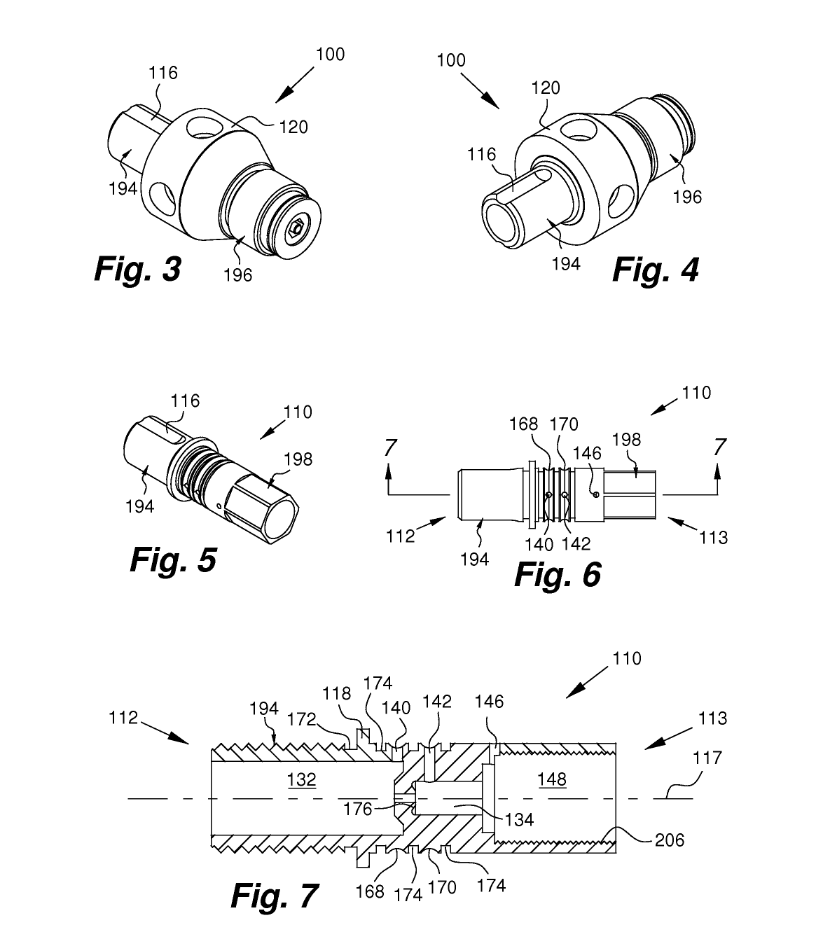

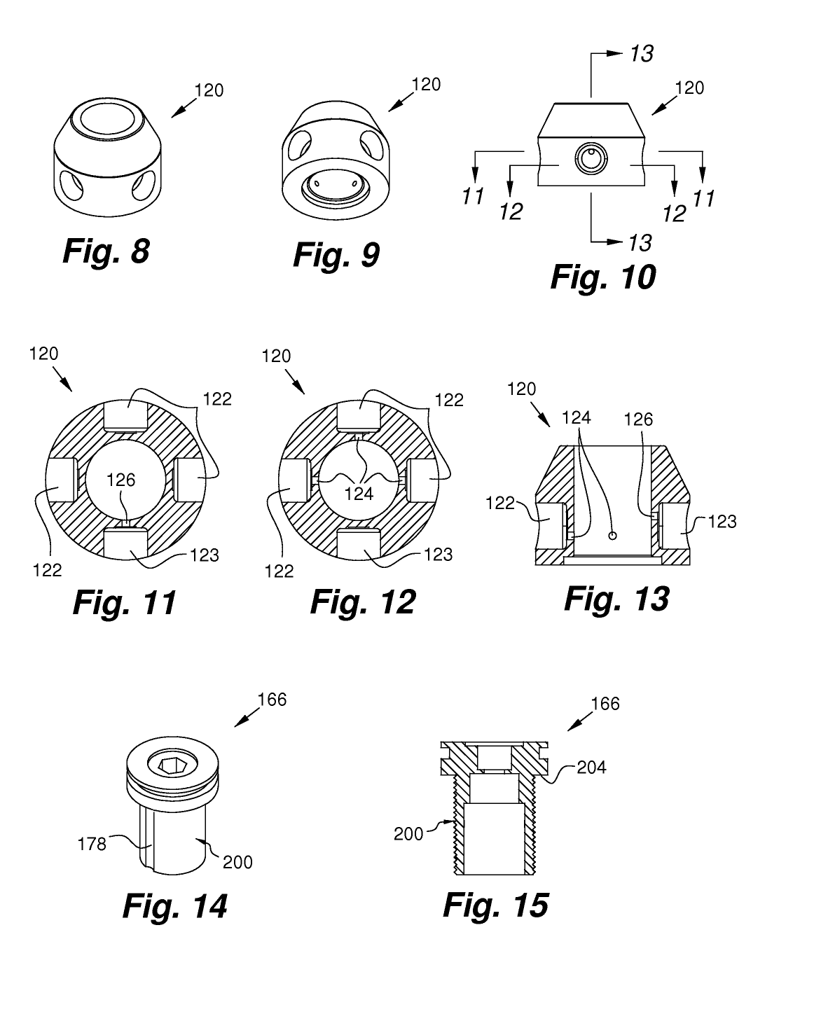

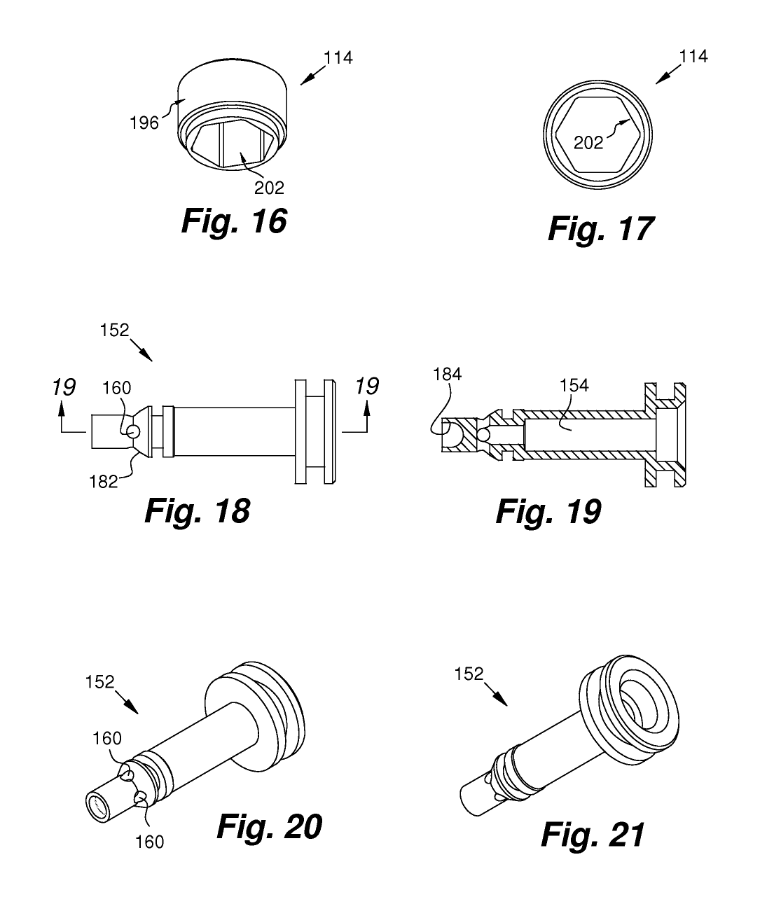

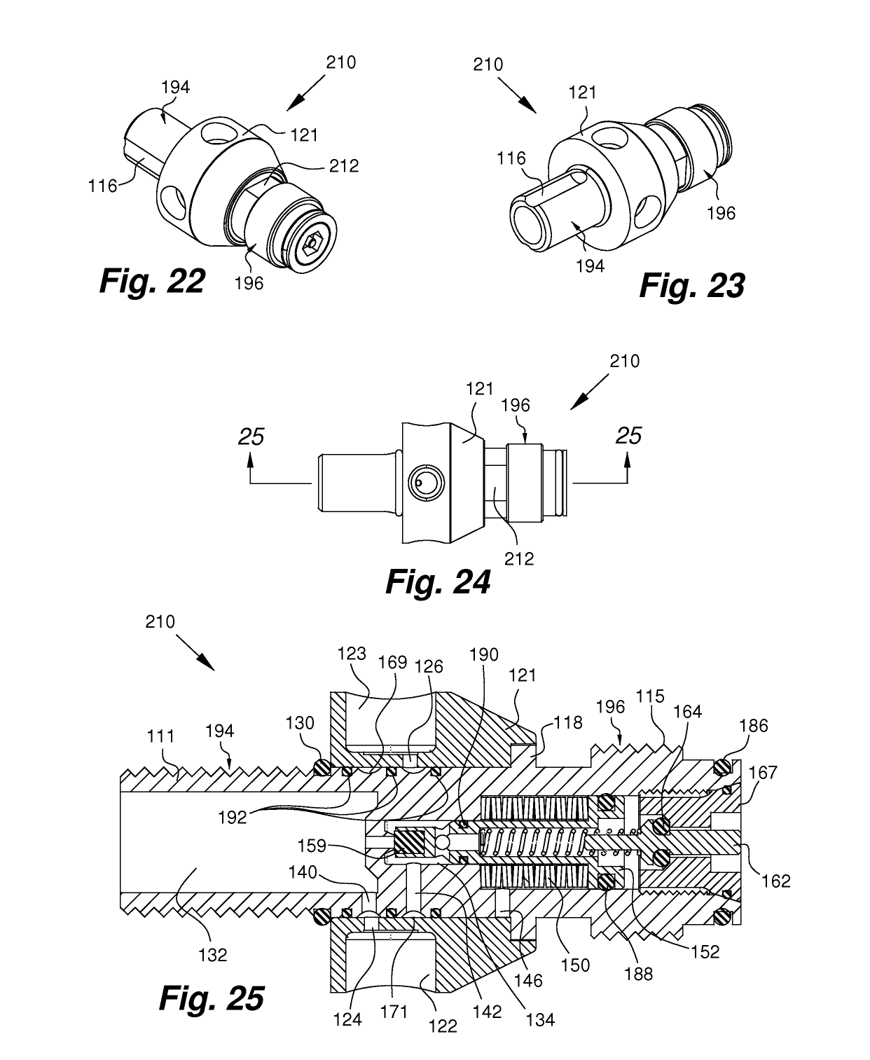

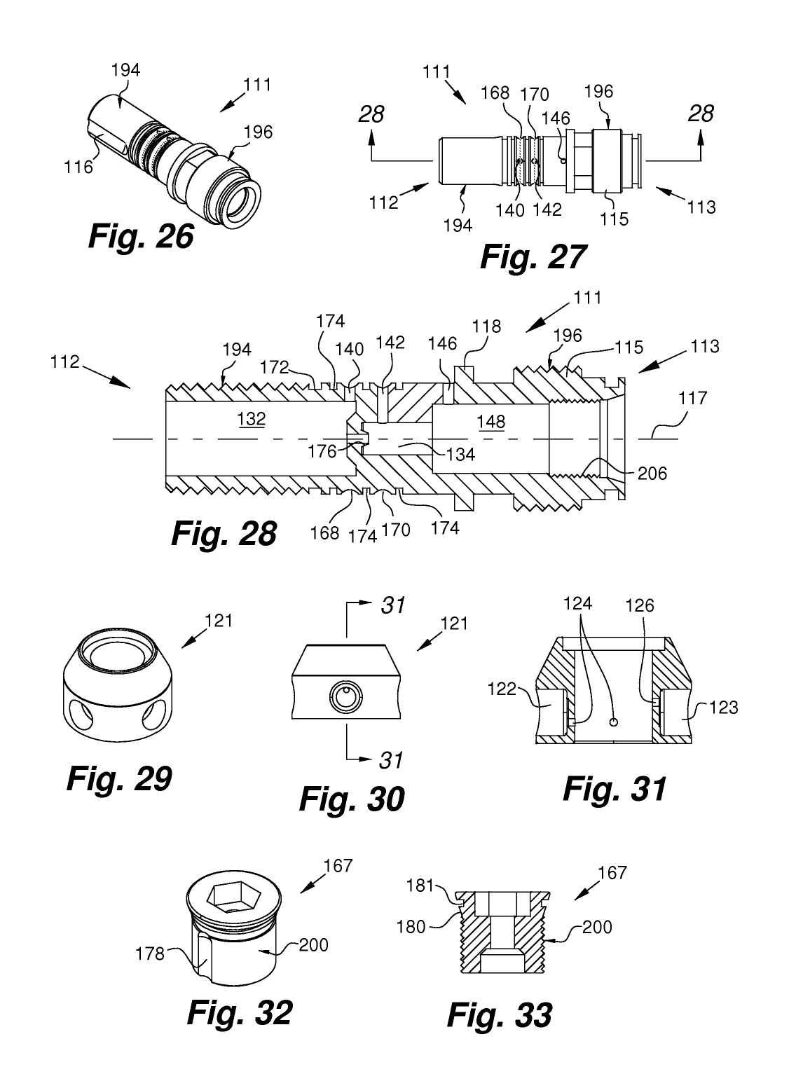

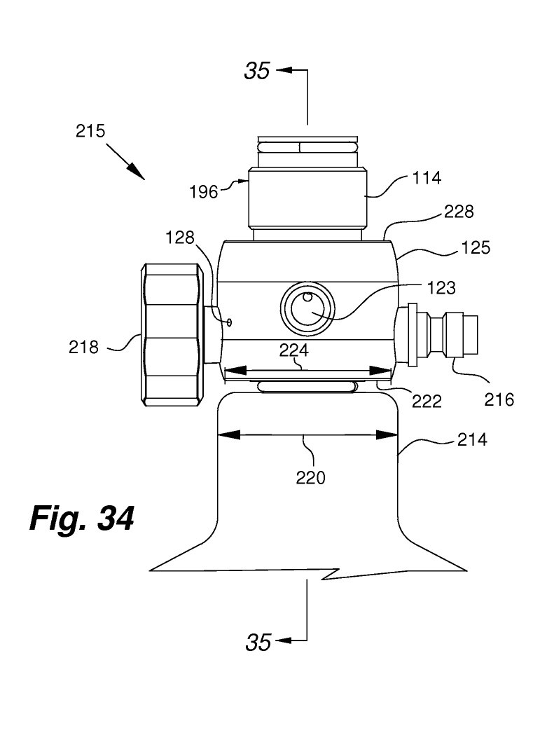

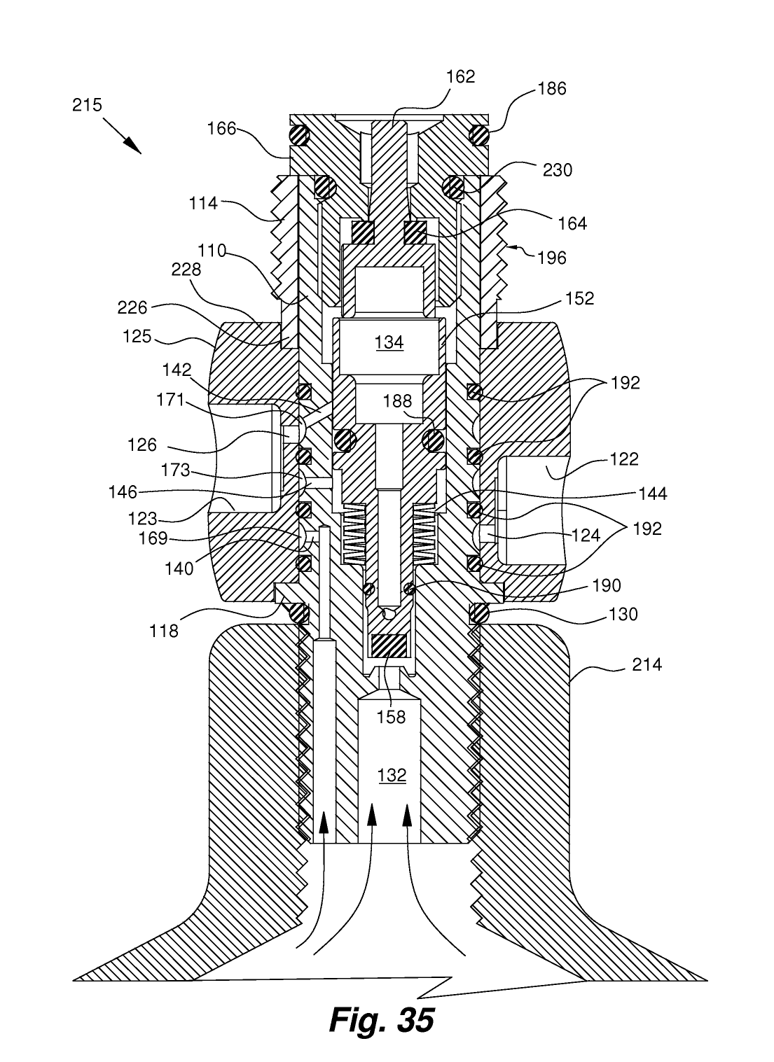

In particular embodiments, such as the one depicted in FIGS. 1-4, the application interface member 114 is adapted to axially receivingly engage the regulator body 110. Further, as depicted for example in FIG. 2, the regulator body 110 and the application interface 114 member may also be adapted such that the application interface member 114 can axially receivingly engage the regulator body 110 in non-rotatable fashion at multiple rotational positions with respect to the regulator body 110. Additionally, in certain embodiments, the regulator body 110 includes a torque engagement portion 198 (see, for example, FIG. 5) adapted to serve two purposes. The first purpose is to cooperate with the inner portion 202 of the application interface member 114 to prevent its rotation with respect to the regulator body 110 when the application interface member 114 is in receiving engagement with the regulator body 110. The second purpose is to engage a torque tool, such as a wrench, to assist in the threaded engagement of the regulator body 110 to a source fitting 214 and threaded removal therefrom.

Referring to FIG. 1, embodiments may further comprise a poppet subsystem and a retainer member 166. The poppet subsystem may comprise, for example, a poppet member 162, a poppet spring 156 and a poppet seal member 164. The regulator valve subsystem in most embodiments is adapted to be housed generally within the regulator body 110. The retainer member 166 is typically adapted to threadedly engage the regulator body 110 proximate the application end 113 and thereby limit the movement of the regulator valve subsystem and the poppet subsystem with respect to the regulator body 110 in a direction from the source end 112 toward the application end 113. This threaded engagement generally occurs between the outer threading 200 of the retainer member 166 and the inner threaded portion 206 of the regulator body 110. The retainer member 166 typically includes one or more retainer member bleed channels 178 to aid in safely removing the retainer member 166 while pressurized gas remains in the low pressure chamber 134.

In certain embodiments, such as the one shown in FIG. 1, the retainer member 166 may be adapted such that threaded engagement of the retainer member 166 to the regulator body 110 will also limit the movement of the application interface member 114 and the port collar 120 with respect to the regulator body 110 in a direction from the source end 112 toward the application end 113. This may involve direct or indirect contact between an axial detent face 204 of retainer member 166, and the application interface member 114. In such embodiments, the regulator body 110 typically has a first axial detent 118 for limiting the movement of the application interface member 114 and the port collar 120 with respect to the regulator body 110 in a direction from the application end 113 toward the source end 112. In a typical such embodiment, the regulator body 110 can first be tightly threaded into the source fitting, then the port collar 120 can be axially slid onto the regulator body and seated against the first axial detent 118, the application interface member 114 can be axially slid onto the regulator body 110 and into contact with the port collar 120, the regulator valve subsystem and poppet subsystems can be inserted into the valve chamber 148 of the regulator body 110, and finally the retainer member 166 can be tightly threaded into the regulator body 110 to secure the assembly of the entire regulator system.

In particular embodiments, the port collar 120 is rotatable about the regulator body 110 when the port collar 120 is in its mounted position. In other embodiments, the port collar 120 is non-rotatable about the regulator body 110 when the port collar 120 is in its mounted position. This non-rotatability may be as a result of frictional engagement caused by the axial securement of the port collar 120 with respect to the regulator body 110 when the embodiment is in assembled form and the retainer member 166 is fully tightened. In such a case, the port collar may be rotated, to reposition a pressure gauge for example, simply by momentarily removing the gas receipt fitting of the application device and loosening the retainer member 166. Alternatively or additionally, in some embodiments the non-rotatability of the port collar 120 may be established by way of, for example, the engagement of complimentary male and female rotation detent features or tapered surfaces (not shown).

An additional embodiment of a gas pressure regulator system is depicted generally at 210 in FIGS. 22-25, with respective components being further depicted in FIGS. 26-33. Embodiment 210 comprises a regulator body 111, a port collar 121, a seal member 159, a retainer member 167 and a torque engagement portion 212. In this embodiment, the application interface member 115 is integrally formed with the body member 111. As shown, for example, in FIGS. 32 and 33, the retainer member 167 includes outer threading 200, a retainer member seal groove 181 and a poppet seal chamfer 180.

FIGS. 34 and 35 illustrate a further embodiment of a gas pressure regulator system generally at 215. Such an embodiment may include an example of a port collar 125 with a cross-sectional and side profile which is more rounded in shape, as the collar extends from its collar proximal end 222 to its collar distal portion 228. In such a port collar 125, for example, the collar proximal diameter 224 may be generally equal to or less than the neck diameter 220 of an associated source fitting or neck 214 of an associated tank. This may help prevent the collar proximal end 222 from catching on an external object or operator of the system as the regulator is moved toward the source end 112 during use.

An embodiment such as the one illustrated at 215 in FIGS. 34 and 35 may include a third annular channel 173 in fluid communication between a high side bore 146 and, for example, a collar ambient bore 128. With such a configuration, the ambient pressure chamber 144 may remain in fluid communication with the ambient outside environment regardless of the rotational orientation of the port collar 125 with respect to the regulator body 110. Such embodiments may include four port collar o-rings 192. FIG. 34 also illustrates where a pressure gauge 218 and a fill nipple 216 may be connected to a regulator system, such as the on depicted at 215. The embodiment illustrated in FIG. 35 may also include a poppet spring (not shown in FIG. 35) and a retainer member seal 230.

As illustrated in FIG. 35, for example, in certain embodiments the application interface member 114 may include an interface proximal end 226. In such a case, the collar distal portion 228 of the port collar 125 may be adapted to at least partially axially receive the interface proximal end 226, such that the interface proximal end 226, the collar distal portion 228 and the regulator body 110 at least partially axially overlap one another when the system is in assembled configuration. This overlap adaptation may help to reduce the formation of lateral stress concentrations on the regulator body at an axial location where, in embodiments not including this feature (such as the one depicted in FIG. 1), there may otherwise be a non-overlapping face-to-face joint between the application interface member 114 and port collar 120.

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

What is claimed is:

1. A gas pressure regulator system comprising:
(a) a regulator body having a high pressure chamber and a low pressure chamber, the low pressure chamber being adapted to receive pressurized gas from the high pressure chamber in a manner controlled by a regulator valve subsystem; and
(b) a port collar having a high pressure port and low pressure port, and being adapted to receivingly engage the regulator body for placement of the port collar in a mounted position on the regulator body, the high pressure port being in fluid communication with the high pressure chamber when the port collar is in the mounted position, and the low pressure port being in fluid communication with the low pressure chamber when the port collar is in the mounted position.

2. A gas pressure regulator system as defined in claim 1 in which the port collar is rotatable about the regulator body when the port collar is in the mounted position.

3. A gas pressure regulator system as defined in claim 1 in which the port collar is non-rotatable about the regulator body when the port collar is in the mounted position.

4. A gas pressure regulator system as defined in claim 1 in which the port collar is made substantially of aluminum and the regulator body is made substantially of brass.

5. A gas pressure regulator system as defined in claim 1 in which the regulator body has a high side bore, a low side bore, and an ambient bore, and is adapted such that when the port collar is in the mounted position:
(a) the high side bore is in fluid communication between the high pressure chamber and the high pressure port;
(b) the low side bore is in fluid communication between the low pressure chamber and the low pressure port; and
(c) the ambient bore is in general fluid communication with the ambient environment.

6. A gas pressure regulator system as defined in claim 5 in which the regulator body has a first annular groove and a second annular groove, the high side bore being in fluid communication between the high pressure chamber and the first annular groove, and the low side bore being in fluid communication between the low pressure chamber and the second annular groove.

7. A gas pressure regulator system as defined in claim 6 in which the regulator body has three gasket grooves, the first annular groove and the second annular groove each being axially flanked by two of the gasket grooves.

8. A gas pressure regulator system as defined in claim 1 in which the regulator body further has a source end and an application end, and the gas pressure regulator system further comprises an application interface member adapted to:
(a) engage the regulator body proximate the application end in non-rotatable fashion; and
(b) releasably engage a gas receipt fitting of an application device.

9. A gas pressure regulator as defined in claim 8 in which the regulator body has threading proximate the source end, the threading being adapted to threadedly engage a source fitting in fluid communication with a reservoir for pressurized fluid, and the application interface member is adapted to threadedly engage the gas receipt fitting of the application device.

10. A gas pressure regulator system as defined in claim 8 in which the regulator body and the application interface member are integrally formed.

11. A gas pressure regulator system as defined in claim 8 further comprising a regulator valve subsystem, a poppet subsystem and a retainer member, the regulator valve subsystem being adapted to be housed generally within the regulator body, the retainer member being adapted to threadedly engage the regulator body proximate the application end and thereby limit the movement of the regulator valve subsystem and the poppet subsystem with respect to the regulator body in a direction from the source end toward the application end.

12. A gas pressure regulator system as defined in claim 8 in which the application interface member is adapted to axially receivingly engage the regulator body.

13. A gas pressure regulator system as defined in claim 12 in which the regulator body and the application interface member are adapted such that the application interface member can axially receivingly engage the regulator body in non-rotatable fashion at multiple rotational positions with respect to the regulator body.

14. A gas pressure regulator system as defined in claim 13 in which the regulator body includes a torque engagement portion adapted to:
(a) engage an inner surface of the application interface member so as to prevent the application interface member from rotating with respect to the regulator body when the application interface member is in receiving engagement with the regulator body; and
(b) engage a torque tool to assist in the threaded engagement of the regulator body to a source fitting and threaded removal therefrom.

15. A gas pressure regulator system as defined in claim 12 further comprising a regulator valve subsystem, a poppet subsystem and a retainer member, the regulator valve subsystem being adapted to be housed generally within the regulator body, the retainer member being adapted to threadedly engage the regulator body proximate the application end and thereby limit the movement of the regulator valve subsystem, the poppet subsystem, the application interface member and the port collar with respect to the regulator body in a direction from the source end toward the application end, the regulator body further having a first axial detent for limiting the movement of the application interface member and the port collar with respect to the regulator body in a direction from the application end toward the source end.

16. A gas pressure regulator system comprising:
(a) regulator valve subsystem;
(b) a poppet subsystem;
(c) a regulator body having a source end, an application end, a high pressure chamber, a low pressure chamber, a high side bore and a low side bore, the low pressure chamber being adapted to receive pressurized gas from the high pressure chamber in a manner controlled by the regulator valve subsystem, the regulator valve subsystem being housed generally within the regulator body;
(d) a port collar having a plurality of high pressure ports and a low pressure port, and being in receiving engagement with the regulator body and axially restrained in a mounted position on the regulator body, the high pressure ports being in fluid communication with the high pressure chamber by way of the high side bore, and the low pressure port being in fluid communication with the low pressure chamber by way of the low side bore;
(e) an application interface member engaged with the regulator body proximate the application end in non-rotatable fashion, and adapted to releasably engage a gas receipt fitting of an application device; and
(f) a retainer member, the retainer member being threadedly engaged with the regulator body proximate the application end and thereby limiting the movement of the regulator valve subsystem and the poppet subsystem with respect to the regulator body in a direction from the source end toward the application end.

17. A gas pressure regulator as defined in claim 16 in which:
(a) the regulator body proximate the source end is adapted to threadedly engage a source fitting in fluid communication with a reservoir for pressurized fluid, and thereby releasably secure the reservoir in fluid communication with the high pressure chamber; and
(b) the application interface member is adapted to threadedly engage the gas receipt fitting of the application device.

18. A gas pressure regulator system as defined in claim 16 in which:
(a) the regulator body has a first annular groove, a second annular groove, and three gasket grooves, the high side bore being in fluid communication between the high pressure chamber and the first annular groove, the low side bore being in fluid communication between the low pressure chamber and the second annular groove, and the first annular groove and the second annular groove are each axially flanked by two of the gasket grooves; and
(b) the gas pressure regulator system further comprises three port collar o-rings, each of the port collar o-rings being positioned within a respective one of the gasket grooves and generally between the regulator body and the port collar.

19. A gas pressure regulator system comprising:
(a) regulator valve subsystem;
(b) a poppet subsystem;
(c) a regulator body having a source end, an application end, a first axial detent, a high pressure chamber, a low pressure chamber, a high side bore and a low side bore, the low pressure chamber being adapted to receive pressurized gas from the high pressure chamber in a manner controlled by the regulator valve subsystem, the regulator valve subsystem being housed generally within the regulator body, the regulator body proximate the source end is adapted to threadedly engage a source fitting in fluid communication with a reservoir for pressurized fluid, and thereby releasably secure the reservoir in fluid communication with the high pressure chamber, the regulator body further having a first annular groove, a second annular groove, and three gasket grooves, the high side bore being in fluid communication between the high pressure chamber and the first annular groove, the low side bore being in fluid communication between the low pressure chamber and the second annular groove, and the first annular groove and the second annular groove are each axially flanked by two of the gasket grooves;
(d) a port collar having a plurality of high pressure ports and a low pressure port, and being in receiving engagement with the regulator body and axially restrained in a mounted position on the regulator body, the high pressure ports being in fluid communication with the high pressure chamber by way of the high side bore, and the low pressure port being in fluid communication with the low pressure chamber by way of the low side bore;
(e) an application interface member axially receivingly engaged with the regulator body proximate the application end in non-rotatable fashion, and adapted to threadedly engage a gas receipt fitting of an application device;
(f) a retainer member, the retainer member being threadedly engaged with the regulator body proximate the application end and thereby limiting the movement of the regulator valve subsystem and the poppet subsystem with respect to the regulator body in a direction from the source end toward the application end, the port collar and the application interface member being axially secured on the regulator body by way of cooperation between the retainer member and the first axial detent; and
(g) three port collar o-rings, each of the port collar o-rings being positioned within a respective one of the gasket grooves and generally between the regulator body and the port collar.

20. A gas pressure regulator as defined in claim 20 further comprising a high pressure burst disk assembly threadedly affixed to one of the high pressure ports, and a low pressure burst disk assembly threadedly affixed to the low pressure port.

21. A gas pressure regulator as defined in claim 12 in which the application interface member includes an interface proximal end and the port collar includes a collar distal portion, the collar distal portion being adapted to at least partially axially receive the interface proximal end such that the interface proximal end, the collar distal portion and the regulator body at least partially axially overlap one another.
